(19) United States
(12) Patent Application Publication
(10) Pub. No.: US 2011/0314216 A1
(43) Pub. Date: Dec. 22, 2011

(54) Method and Device for Reducing the Remanence of Data Stored on a Recording Medium

(75) Inventors: Fabien Alcouffe, Colombes (FR); Sebastien Breton, Arconnay (FR); Eric Weber, Cormeilles en Vexin (FR)

(73) Assignee: THALES, Neuilly sur Seine (FR)

(21) Appl. No.: 13/026,488

(22) Filed: Feb. 14, 2011

Related U.S. Application Data
(63) Continuation of application No. 12/746,676, now abandoned.

(30) Foreign Application Priority Data
Dec. 7, 2007 (FR) FR0708551

(51) Int. Cl. G06F 12/00; G06F 12/02

(52) U.S. Cl. 711/112; 711/170; 711/111; 711/E12.001; 711/E12.002

(57) ABSTRACT

In a method of reducing the remanence of data stored in the memory space of a recording medium, in which at least a portion of the data stored in the memory space is moved in blocks according to a cycle repeated over time, the cycle includes choosing a number N of data blocks to be moved, and, as long as the number D of blocks moved during the cycle is less than N: a data block Bᵢ to be moved is chosen, a free memory area is chosen; and the data block Bᵢ is moved to this free area.

### CROSS-REFERENCE TO RELATED APPLICATIONS

This application is a continuation of pending U.S. application Ser. No. 12/746,676, filed on Jun. 7, 2010, which is a National Stage of International patent application PCT/EP2008/066690, filed on Dec. 3, 2008, now expired, which claims priority to foreign French patent application No. FR 07 08551, filed on Dec. 7, 2007, the disclosures of which are hereby incorporated by reference in their entirety.

### FIELD OF THE INVENTION

The present invention relates to a method and a device for reducing the remanence of data stored on a recording medium. The invention applies in particular to magnetic media, such as hard disks, in order to facilitate complete erasure of the data written onto these media.

### BACKGROUND OF THE INVENTION

A thorough examination of spent magnetic media, such as hard disks, is at the present time a precious source of information, both for the police services and for economic espionage. Furthermore, a large number of hard disks are destroyed when replacing hardware so as to prevent inopportune disclosure of confidential data.

In general, for a computer unit provided with a rewritable memory, the user wishing to remove a first data set merely removes the address pointing to the recording blocks of this data set. At this stage, said unaltered first data set is therefore still present in the memory, even if the memory areas receiving these data blocks are considered as available for receiving another data set. Thereafter, during use of the unit, it is these areas that are likely to be used again to receive blocks of a second data set. The first data set is therefore erased, partly or entirely, by the second data set. However, owing to the technologies currently used, especially in the case of hard disks, a data set leaves remaining traces even after it has been erased several times. For example, in many hard disks the magnetic remanence of data is such that, even after several tens of memory erasure operations, the data set is still sometimes recoverable with appropriate means, such as scanning electron microscopes.

Now, specific software has been developed to enable data to be effectively erased. Notably, the following may be mentioned:
the Xerox Corporation patent application published on Dec. 5, 2002 under the reference US 2002/181134;
the methods proposed by Peter Gutmann on his Internet site http://www.cs.auckland.ac.nz/˜pgut001/pubs/secure_del.html; and
the methods recommended by the United States Department of Defense, notably in the DoD document 5220.22-M (section 8-306), (http://www.dtic.mil/whs/directives/corres/html/522022m.htm).

These methods provide a secure way of erasing data recorded on a magnetic medium thanks to a particular pattern or pseudo random data being repeatedly written onto the medium.

However, these a posteriori methods of removing remanence are very lengthy as they require many rewriting cycles. This drawback may sometimes prove to be catastrophic, for example when it is desired to erase confidential data from a computing system in an emergency when there is an intrusion into the system.

It is also possible to encipher the data during use of the medium, that is to say to store only encrypted data. However, the encryption remains vulnerable since it depends on secret elements liable to be compromised. In addition, because of the rapid developments in technologies and algorithms, nothing guarantees that the encryption cannot be broken several years after a recording medium has been scrapped.

### SUMMARY OF THE INVENTION

The present invention reduces the remanence of data stored on a recording medium. For this purpose, an embodiment of the invention includes a method of reducing the remanence of data stored in the memory space of a recording medium, wherein at least a portion of the data stored in the memory space is moved in blocks according to a cycle repeated over time, the cycle including choosing a number N of data blocks to be moved, and, as long as the number D of blocks moved during the cycle is less than N: a data block Bᵢ to be moved is chosen, from among the N-D blocks having not yet been moved; a free memory area is chosen; and the data block Bᵢ is moved to this free area.

According to another embodiment, the method includes an additional step of modifying the logic state of the memory area freed by the movement of the data block Bᵢ so as to reduce the remanence of the data in said memory area.

Since the memory area freed by the movement of the data block Bᵢ is generally formed from a series of bits, the logic states of at least some of the bits of the freed memory area may be inverted. According to another embodiment, a pseudo random data pattern is written into the freed memory area.

According to yet another embodiment, the free area chosen to receive the moved data block is selected pseudo randomly from among the free areas present in the memory space.

According to at least one embodiment, the data block chosen to be moved is the block of random index i among the N-D data blocks having not yet been moved.

According to another embodiment, the recording medium is a magnetic medium and may be a hard disk.

Another embodiment of the present invention includes a device for reducing the remanence of data stored in the memory space of a recording medium, the device including a computer unit, the recording medium and the computer unit communicating via a data bus, the device including a memory management unit implementing the method of reducing data remanence as described above, the memory management unit maintaining a look-up table that maps the physical addresses of the data blocks stored and moved in the memory space of the recording medium to the visible logic addresses of the applications executed by the computer unit.

### BRIEF DESCRIPTION OF THE DRAWINGS

The above and other aspects, features and advantages of the present invention will more readily become apparent from the following detailed description, given by way of nonlimiting example and in conjunction with the attached drawings, in which:

FIG. 1 is an illustration of the execution of a cycle of the data remanence reduction method according to the invention;

FIG. 2 illustrates one embodiment of a device employing the method according to the invention; and

FIG. 3 is an illustration of the operation of a memory management unit employing the method according to the invention.

### DETAILED DESCRIPTION

The method according to embodiments of the present invention is based on the following observation: in general, the longer data remain in the same memory location of a recording medium, the greater the remanence of said data, in other words the deeper the traces left by this data. By moving a data set from one memory location to another memory location with a sufficiently high frequency, the time during which a data set remains at the same location is reduced and consequently the remanence of this data set on the recording medium is maintained at a low level.

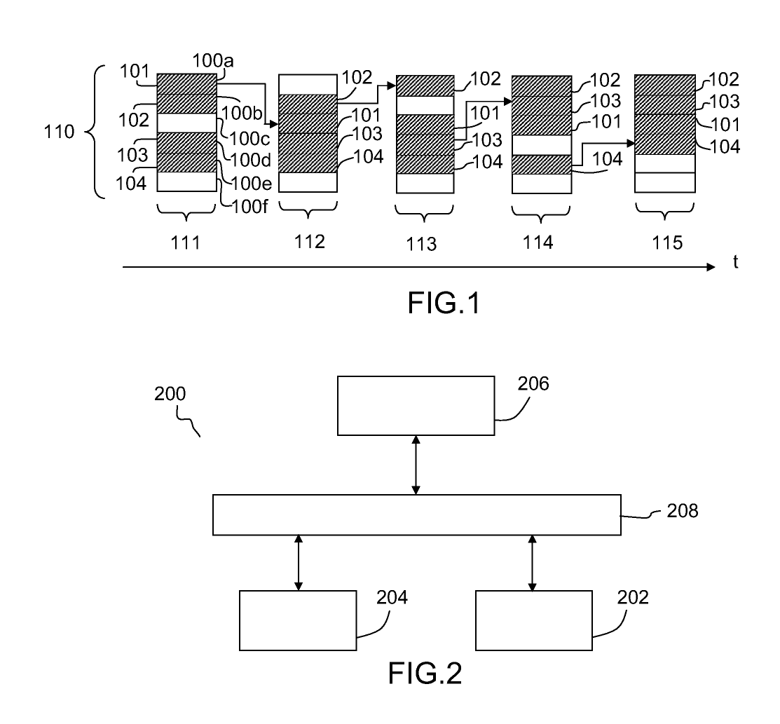

FIG. 1 illustrates the execution of a cycle of the remanence reduction method according to the invention. A given memory space 110, which covers all or part of the memory of a recording medium, is represented at various stages during application of the method. This memory space 110 is split into several memory areas 100a, 100b, 100c, 100d, 100e and 100f. The memory areas containing data are shown cross-hatched in FIG. 1, whereas the free areas are left empty. For the sake of simplifying the description, the number of areas shown in FIG. 1 is restricted to a small number, but the method may be applied to a very large number of areas. In the case of a hard disk, an area corresponds for example to a memory block indicated by the allocation table of the file system. The memory space in FIG. 1 comprises six areas 100a, 100b, 100c, 100d, 100e and 100f, two areas being free, namely the third area 100c and the sixth area 100f, whereas the first 100a, second 100b, fourth 100d and fifth 100e areas are each occupied by a data block 101, 102, 103, 104. The method according to the invention is iterative and cyclic. A cycle comprises several iterations and is terminated when a sufficient number of data blocks, preferably all the data blocks, have been moved at least once. The number of blocks to be moved during a cycle is chosen according to the level of remanence remaining in the memory space 110 that can be tolerated for the data. This is because the larger the number of blocks moved during a cycle, the lower the average remanence of the data over all the memory areas.

In the initial state 111 of the medium, no data block has yet been moved by the remanence reduction method. During a cycle, the method according to the example shown in FIG. 1 moves, at each iteration, the first data block that has not yet been moved to the first free area of the medium 100. In the example, it is therefore the first data block 101 which is chosen to be moved to the first free area, i.e. the third area 100c. The movements of data blocks are shown in FIG. 1 by arrows.

In the second state 112 of the medium 100, after the first data block 101 has been moved, the first area 100a is freed and the third area 100c is occupied by the first data block 101. Thus, the second 100b, third 100c, fourth 100d and fifth 100e areas are occupied by data and the first 100a and sixth 100f areas are free. Next, the first data block that has not yet been moved is chosen to be transposed. In the example, this is the second data block 102 that is moved to the first free area, that is to say the first area 100a.

In the third state 113 of the medium 100, after the second data block 102 has been moved, the second area 100b is freed and the first area 100a is again occupied. Thus, the first 100a, third 100c, fourth 100d and fifth 100e areas are occupied whereas the second 100b and sixth 100f areas are free. At this stage in the execution of the method, the first data block not having been moved is then the third data block 103 occupying the fourth area 100d of the medium 100. This third data block 103 is moved to the first free area, i.e. the second area 100b of the medium 100.

In the fourth state 114 of the medium 100, after the third data block 103 has been moved, the fourth area 100d is freed and the second area 100b is occupied. Thus, the first 100a, second 100b, third 100c and fifth 100e areas are occupied whereas the fourth 100d and sixth 100f areas are free. Next, the fourth data block 104, the only data block not having been moved, is transposed to the first free area, i.e. the fourth area 100d.

In the fifth state 115 of the medium 100, after this last movement of a data block, 104, the first four areas 100a, 100b, 100c and 100d are occupied by data and the fifth 100e and sixth 100f areas are free.

A cycle of the method is completed when all the data blocks of the area have been moved at least once. The cycle is then repeated with a frequency F chosen according to the type of recording medium in question, notably according to its remanence characteristics. For example, in the case of a magnetic medium, the cycle repeat frequency F is determined on the basis of the magnetic susceptibility a of the medium 100, a being defined as follows:

$$α = {lim}_{B \to 0} \frac{d M}{d B}$$

in which M is the magnetization of the material constituting the medium 100, and B is the magnetic excitation applied thereto. According to one embodiment, the temperature to which the recording medium is subjected may also be taken into account in choosing the frequency F, the temperature having an influence on the magnetic remanence according to Curie's law, known to those skilled in the art.

In the example shown in FIG. 1, the first block not moved is systematically chosen to be transposed to the first free area of the memory space of the medium 100. However, there are many possible strategies for choosing the data block to be moved at each step of the method, and likewise many strategies for choosing the free area intended to receive the data block moved. For example, a pseudo random choice is conceivable both for the data block to be moved and also for the free area for receiving this block. For example, the data block chosen to be moved is the data block of index i from among the data blocks that have not yet been moved during the cycle, i being equal to a random integer between 1 and N-D, N being the total number of data blocks and D being the number of data blocks that have already been moved.

Moreover, according to one embodiment, only one portion of the memory of the recording medium is involved in the remanence reduction method, the complementary portion of the memory space 110 being managed conventionally, with no remanence reduction. For example, if a hard disk contains confidential data on a first partition and non-sensitive data on a second partition, the method may be applied only to the first partition.

To reduce data remanence further, the method may be supplemented with a step of modifying the state of the areas freed after each data movement. The modifications that can be applied in this step may take many forms. For example, a data pattern may be systematically written into the area freed by the movement, it being possible for the data pattern used to overwrite the freed area to be, for example, a pseudo randomly generated data block. It is also judicious to invert the memory state of the freed area in order to reduce data remanence. To give an example in the case of a hard disk storing binary data, the logic states of each bit, or only some of them, may be inverted in the area freed after a data block has been moved.

FIG. 2 shows another embodiment of a device employing the method according to the invention.

The device 200 comprises an MMU (memory management unit) 202 enabling a computer unit 204 to access the memory space of a recording medium 206 via a system bus 208. Unlike a conventional MMU, the MMU 202 in FIG. 2 employs mechanisms for applying the method according to the invention.

The MMU 202 maintains a correspondence between the physical address of the data stored on the recording medium 206, this address varying over time according to the programmed movements, and the logic address of the data, present at application level. Implementation of the method according to the invention is completely transparent at application level since the MMU 202 updates a look-up table according to the movements of the data blocks made during a cycle.

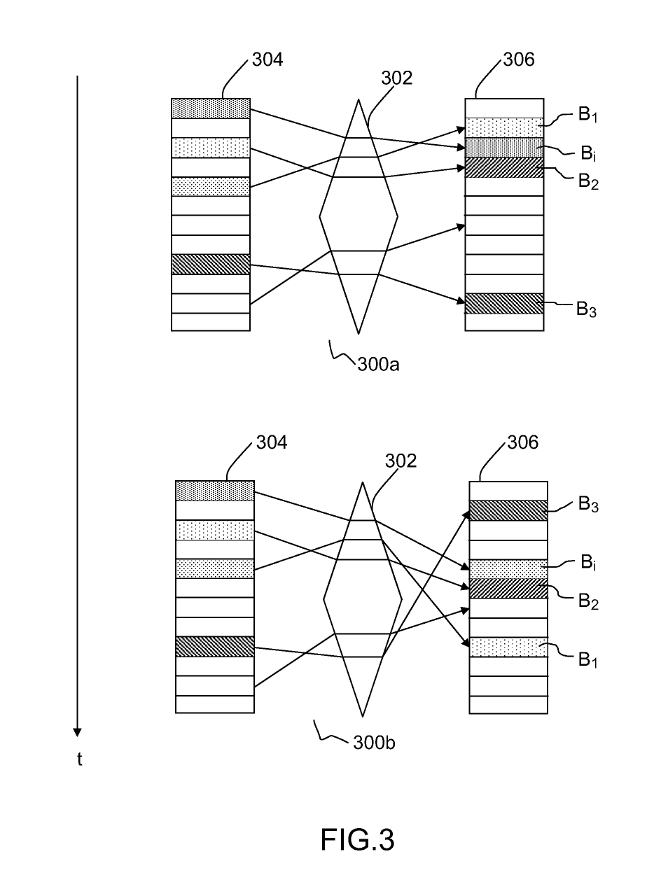

FIG. 3 illustrates operation of the MMU 202 (FIG. 2). The MMU 202 defines a look-up table 302 of the memory addresses. This permutation table 302 contains the correspondences between the logic memory addresses recorded in an allocation table 304 and the physical memory addresses indicating the memory space 306 of the recording medium 206 (FIG. 2).

At initialization of the device, the look-up table 302 establishes links between the logic addresses @L and the physical addresses @P of the data blocks B1, B2, B3 present in the memory space 306. These links are shown by arrows in FIG. 3.

Let the ith data block of the memory space 306 be Bᵢ, the block Bᵢ being referenced in the look-up table 302 by its logic address @L=100 and by its physical address @P=300.

The iterative method of moving the data blocks stored in the memory space 306 is carried out by the MMU 202 (FIG. 2). The iteration involving the movement of the block Bᵢ is explained in detail below, the iterations involving the other blocks B1, B2 and B3 being similar. The iteration includes the following steps:
the MMU 202 calculates a new physical location, in the example @P=700, for placing the block Bᵢ therein, said block being initially accessible at the physical address @P=300;
the MMU 202 copies the block Bᵢ of the initial physical address @P=300 to the new physical address @P=700;
in the example, when this copy has been completed, the integrity of the copied data is checked;
the reference to the physical address of the block Bᵢ is modified in the look-up table 302 as follows: the initial physical address @P=300 is replaced with the new physical address @P=700, while the reference to the logic address @L is left with the same value @L=100;
in the example, the logic state of the data block accessible at the initial physical address @P=300 is modified using one of the aforementioned methods of reducing data remanence (for example, one or more writings, of a randomly or nonrandomly predetermined data block, or else a binary inversion of some of the data).

Once the operation of moving the block Bᵢ has been completed, the cycle continues for the other data blocks, more particularly for those that have not yet been moved. As shown in FIG. 3, through a first state 300a and a second state 300b of the memory space 306, the arrangement of the data blocks changes over the course of time.

According to another embodiment, the method is carried out via a software controller responsible for ordering frequent data movements and for establishing correspondences between the logic addresses of the data blocks and the physical addresses of the memory space.

By applying the method according to the invention it is possible to dispense with many memory rewriting cycles when definitive erasure of the data is desired. The remanence of this data is kept constantly low, thereby making it possible, at any moment, to definitively erase it by a single memory overwrite.

The method according to the invention may be used in the context of cryptographic calculations, which require the storage of sensitive variables. Advantageously, such sensitive variables may be stored in a memory space protected by the remanence reduction method according to the invention so as to avoid any of these variables being compromised after said calculations have been carried out.

The method according to the invention readily applies to technologies such as, but not limited to, magnetic memory media, such hard disks, but also applies to various other types of media, such as rewritable optical media, for example.

What is claimed is:

1. A method of reducing the remanence of data stored in a memory space of a recording medium, comprising at least a portion of the data stored in the memory space being moved in blocks according to a cycle repeated over time, the cycle comprising at least the following steps:
a number N of data blocks to be moved is chosen; and
as long as the number D of blocks moved during the cycle is less than N:
a data block Bᵢ to be moved is chosen;
a free memory area is chosen; and
the data block Bᵢ is moved to the free memory area.

2. The method as claimed in claim 1, further comprising modifying the logic state of the memory area freed by the movement of the data block Bᵢ so as to reduce the remanence of the data in said memory area.

3. The method as claimed in claim 2, wherein the memory area freed by the movement of the data block Bᵢ is formed from a series of bits, wherein the modifying the logic state of the freed memory area comprises a reversal of the logic state of at least some of the bits of the freed memory area.

4. The method as claimed in claim 2, wherein the memory area freed by the movement of the data block Bᵢ is formed from a series of bits, and wherein a pseudo random data pattern is written into the freed memory area.

5. The method as claimed in claim 1, wherein the free area chosen to receive the moved data block is selected pseudo randomly from among the free areas present in the memory space.

6. The method as claimed in claim 1, wherein the data block chosen to be moved is the block of random index i among the N-D data blocks having not yet been moved.

7. The method as claimed in claim 1, wherein the recording medium is a magnetic medium.

8. The method as claimed in claim 7, wherein the recording medium is a hard disk.

9. A device for reducing the remanence of data stored in a memory space of a recording medium, the device comprising:
a computer unit, the recording medium and the computer unit communicating via a data bus; and
a memory management unit implementing the method as claimed in claim 1, wherein the memory management unit maintains a look-up table that maps the physical addresses of the data blocks stored and moved in the memory space of the recording medium to the visible logic addresses of the applications executed by the computer unit.
